(19) United States
(12) Patent Application Publication
(10) Pub. No.: US 2005/0075763 A1
(43) Pub. Date: Apr. 7, 2005

(54) Method and device for automatically monitoring and controlling an aircraft path

(76) Inventor: Philippe L. Brigode, Bruxelles (BE)

Correspondence Address: Gregory J. Nelson;NELSON & ROEDIGER, Suite 212, 3333 E. Camelback Road, Phoenix, AZ, 85018, US

(21) Appl. No.: 10/866,632

(22) Filed: Jun. 12, 2004

(30) Foreign Application Priority Data
Dec. 13, 2001 (BE) BE 2001/0811

(51) Int. Cl. G06F 7/00; G05D 3/00

(52) U.S. Cl. 701/11; 701/3

(57) ABSTRACT

Method and device for automatically monitoring and controlling an aircraft path Method consisting in comparing the position of an aircraft (1) with respect to at least one safety volume (2) whose coordinates are stored on board the aircraft (1). As soon as it is detected that the aircraft (1) enters the at least one safety volume (2), means of automatic piloting are activated automatically—hence with no human intervention—and pilot the aircraft (1) according to a disengagement trajectory (3) for exiting the safety volume (2), until the aircraft (1) has exited the safety volume (2).

### FIELD OF THE INVENTION

The invention relates to a method and a device for automatic piloting of an aircraft on board of which has been stored a set of coordinates determining at least one safety volume.

### STATE OF THE ART

Methods of automatic piloting are well known in the aeronautical field. They consist in automatically piloting, hence without human intervention, an aircraft so that the latter follows a determined trajectory. This trajectory generally depends on a properly established flight plan.

Patent JP 11-044551 moreover describes a navigation system which makes it possible to take account of danger zones, such as a mountain or a zone of strong atmospheric disturbances, and to calculate an alternative trajectory which avoids these danger zones. The coordinates of these danger zones, also referred to as safety volumes, are generally stored on board the aircraft, for example in a navigation database. The alternative trajectory is supplied to the automatic pilot which thereafter steers the aircraft so that it follows this alternative trajectory.

Although such methods of automatic piloting generally operate well, it is desirable to improve the safety of these methods.

### SUMMARY OF THE INVENTION

The aim of the invention is to provide a method and a device for automatically monitoring and controlling the trajectory of an aircraft guaranteeing greater safety.

To this end, the method of automatic piloting of an aircraft according to the invention is characterized in that the method comprises the following steps:
monitoring whether the aircraft is in the at least one safety volume by comparing position coordinates of the aircraft with respect to the coordinates determining the at least one safety volume;
providing a disengagement trajectory for exiting the at least one safety volume and automatically activating means of automatic piloting of the aircraft according to the said disengagement trajectory as soon as the aircraft is in the at least one safety volume.

In the known methods, it is a pilot of the aircraft who triggers the automatic pilot. There is therefore a risk of the automatic pilot not being triggered either by omission, or by incapacity, or by prevention, or for any other reason related to the human factor. The method according to the invention makes it possible to reduce this risk and to better ensure that if an aircraft enters the safety volume, the aircraft will automatically perform a disengagement manoeuvre to exit the said volume. Specifically, the method according to the invention activates the automatic disengagement manoeuvre automatically, hence without human intervention.

Such a safety volume may for example be a safety volume around a mountain, but also a safety volume around a zone occupied by people, such as for example a dwelling zone. In the latter case, the method according to the invention makes it possible to prevent terrorist acts such as acts aimed at making the aircraft crash on the occupied zone, given that the automatic pilot is triggered automatically and that it will pilot the aircraft according to the disengagement trajectory for exiting the zone.

The aircraft need not necessarily be in flight in order for the method to apply. The method can in fact be applied when the aircraft is on the ground, for example before a takeoff phase or after a landing phase. In this case, the disengagement trajectory will be a disengagement trajectory on the ground.

The method according to the invention can also comprise a step of recording the coordinates of the safety volume in storage means on board the aircraft. This also makes it possible to enhance safety by better controlling the way in which the coordinates are recorded, for example by applying methods of encoding and possibly of encryption of the coordinates.

Preferably, the method according to the invention comprises a step of automatic deactivation of any other means of piloting of the airplane once the means of automatic piloting of the aircraft according to the disengagement trajectory have been activated. In this way, no other means of piloting allows the trajectory of the aircraft to be modified while the aircraft is in the safety volume. In the case of an attempted deliberate crashing of the aircraft through a terrorist action, this effectively makes it possible to prevent anybody from forcing the aircraft to crash for example through manual piloting.

It is also preferable that once the means for automatic piloting according to the disengagement trajectory have been activated, these automatic piloting means can not be deactivated while the aircraft is in the safety volume. In the case of an attempted deliberate crashing of the aircraft through a terrorist action, this effectively makes it possible to prevent anybody from deactivating the means of automatic piloting according to the disengagement trajectory.

### BRIEF DESCRIPTION OF THE FIGURES

These aspects as well as other aspects of the invention will be clarified in the detailed description of particular embodiments of the invention, reference being made to the drawings of the figures, in which:

FIG. 1 shows a flowchart of a method of automatic piloting according to the state of the art;

FIG. 2a shows a flowchart corresponding to an example of the steps of a method of automatic piloting according to the invention;

FIG. 2b shows a flowchart corresponding to an example of a further step of a method of automatic piloting according to the invention;

FIG. 3 shows a vertical sectional view of an example illustrating the principle of the invention;

FIG. 4 shows a perspective view of an example of a safety volume according to the invention;

FIGS. 5a, 5b show examples of a disengagement trajectory according to the invention;

FIG. 6 is a flowchart corresponding to an example of the steps of a preferred method of automatic piloting according to the invention;

FIG. 7 shows a simplified diagram of a known system for piloting an airplane;

FIG. 8 shows a schematic diagram of an example of a piloting device according to the invention;

FIG. 9 shows a schematic diagram of an example of a preferred piloting device according to the invention;

FIG. 10 shows a schematic diagram of another example of a preferred piloting device according to the invention.

The figures are not drawn to scale. Generally, like elements are denoted by like references in the figures.

### DETAILED DESCRIPTION OF PARTICULAR EMBODIMENTS

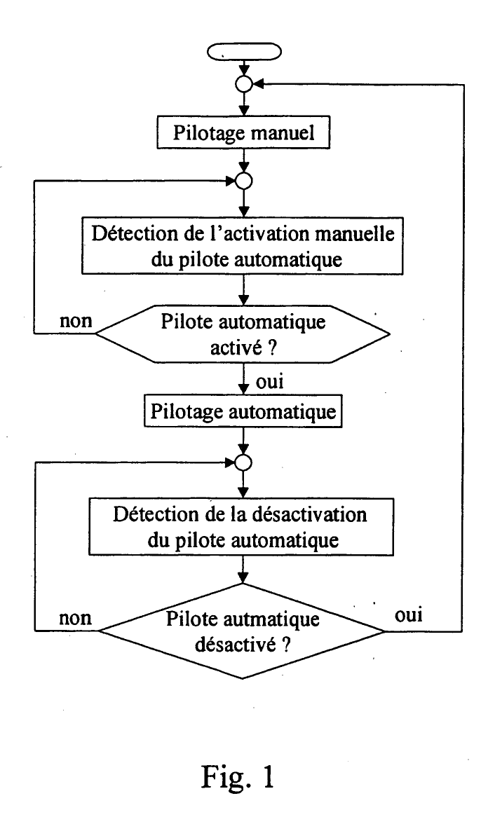

FIG. 1 shows a flowchart of a method of automatic piloting according to the state of the art. It is noted that the switch from manual piloting to automatic piloting of the aircraft (1) is done manually, that is to say the automatic piloting is activated subsequent to an action by a person, generally a pilot of the aircraft (1).

Once in automatic piloting mode, the aircraft (1) automatically follows a determined trajectory, according to a properly established flight plan. Patent JP 11-044551 moreover describes the possibility of the said trajectory taking account of danger zones, such as mountains or zones of strong atmospheric disturbances, and of it therefore being calculated or recalculated in order to avoid such zones. It will be readily understood that this method is effective only if one can be certain that automatic piloting is actually activated and possibly that it remains activated. However, nothing is less certain, in particular in the case of a terrorist action aimed at making the aircraft (1) crash for example.

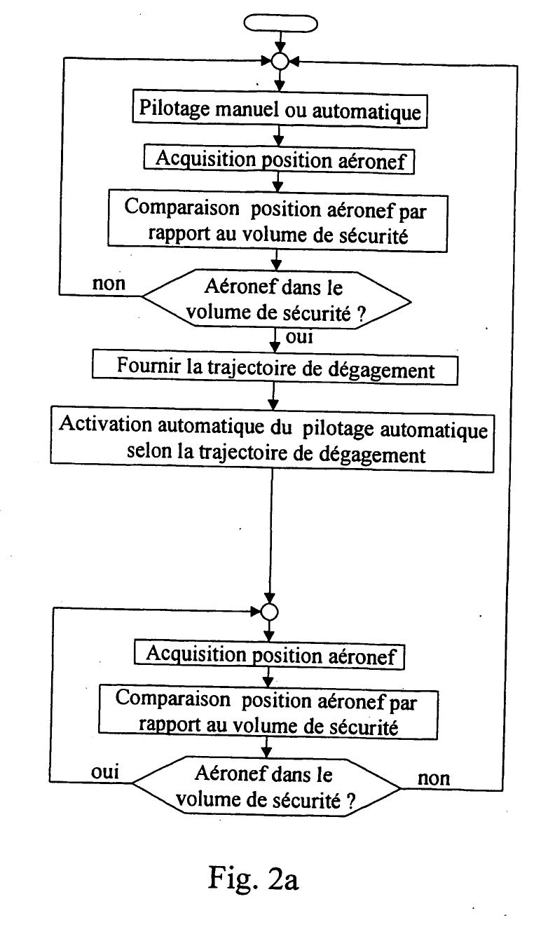

According to a first aspect of the invention, the method is one which comprises a certain number of steps, as illustrated by an exemplary flowchart in FIG. 2a. In this example, one starts from a situation in which the aircraft (1) is in a normal automatic or manual piloting mode. The position of the aircraft (1) is thereafter acquired, for example by means of techniques such as GPS, inertial reference systems, radio beaconing and/or any combination of these techniques and/or of other techniques. Thereafter, the said position of the aircraft (1) is compared with respect to the safety volume (2) such as stored on board the aircraft (1). This comparison is performed for each safety volume (2) stored. If the aircraft (1) is not in any of the safety volumes, then normal automatic or manual piloting is continued. On the other hand, as soon as it is detected that the aircraft (1) is in one of the safety volumes, a disengagement trajectory (3) for exiting this safety volume (2) is provided and the automatic piloting is activated automatically while compelling it to follow the disengagement trajectory (3), the effect of which will be that the aircraft (1) will automatically leave the safety volume (2). Throughout the disengagement manoeuvre, one continues to acquire the position of the aircraft (1) and to compare this position with the safety volume (2). As soon as the aircraft (1) has left the safety volume (2), one reverts automatically to normal automatic or manual piloting.

The method according to the invention can also comprise a further step of recording the at least one safety volume (2) in storage means (52) on board the aircraft (1), as illustrated in FIG. 2b. Such a safety volume (2) may for example be a meshed volume defined by a set of nodes whose coordinates are stored. It is thus possible for example to apply methods of encoding and possibly of encryption of the said coordinates so as to guarantee better safety of these coordinates.

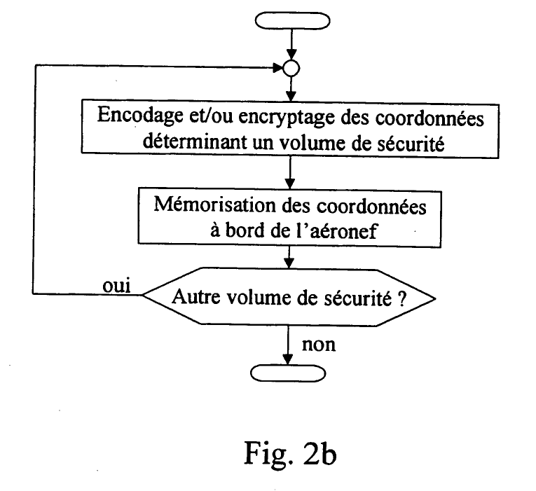

FIG. 3 shows a vertical sectional view of an example of a safety volume (2) which an aircraft (1) enters and a disengagement trajectory (3) for exiting the safety volume (2), which trajectory is imposed on the aircraft (1) by application of the method of automatic piloting according to the invention. In this example, the safety volume (2) is a parallelepiped that the aircraft (1) enters through one of its sides while it is flying substantially in a straight line. In such a case, the disengagement trajectory (3) corresponds to a straightforward gaining of altitude of the aircraft (1).

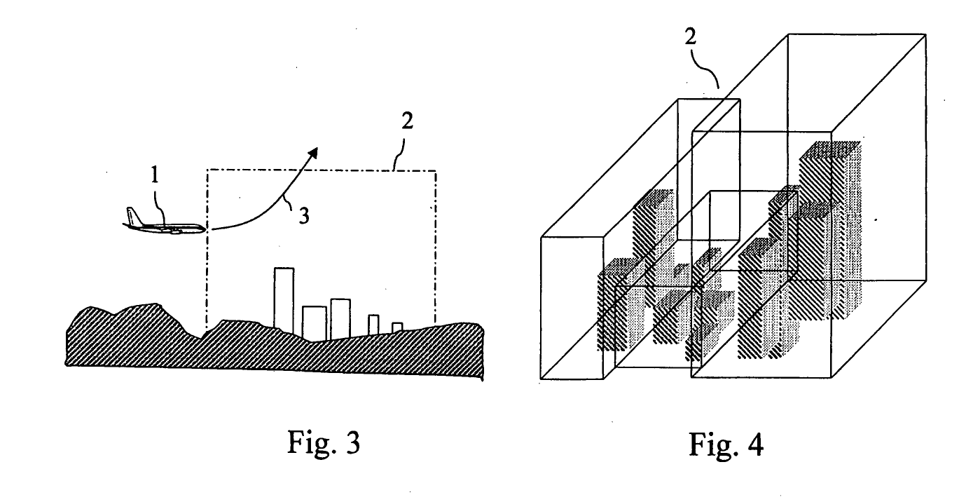

FIG. 4 shows a perspective view of another example of a safety volume (2) according to the invention. In this case, the safety volume (2) consists of a set of adjoining parallelepipeds forming a continuous volume. Such a type of volume may be useful for protecting urban zones for example, while offering one or more corridors allowing normal transit of the aircraft (1), for example with a view to landing at a nearby airport.

Other types and shapes of safety volumes may be imagined as a function of the particular terrain and protection conditions, such as regular or irregular polyhedra or round bodies, or even complex volumes, without thereby departing from the spirit of the invention.

Preferably, the disengagement trajectory (3) for exiting the safety volume (2) by application of the method of automatic piloting according to the invention is a trajectory which would be obtained if the aircraft (1) were piloted so as to make it gain altitude to the maximum of these possibilities, such as for example by actuating an elevator (32) of the aircraft (1) to the maximum of its travel.

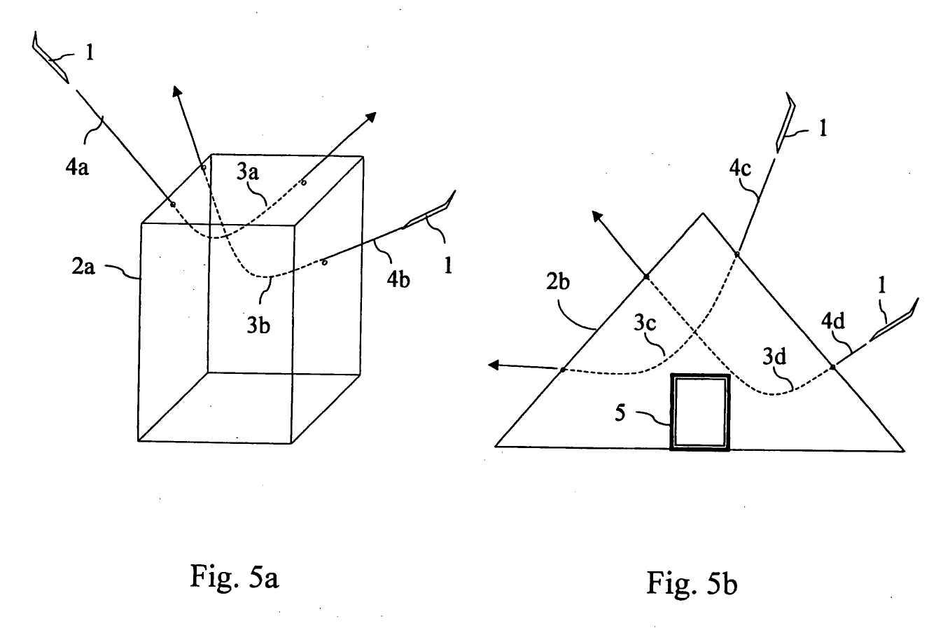

FIGS. 5a and 5b show examples of such disengagement trajectories.

FIG. 5a depicts in perspective a safety volume (2) (2a) of parallelepipedal shape and disengagement trajectories (3a, 3b), corresponding respectively to the points and angles of attack of the safety volume (2) indicated by the trajectories (4a, 4b) of the aircraft (1).

FIG. 5b depicts in vertical section a preferred safety volume (2), such as a volume of substantially pyramidal or conical shape, the said volume enveloping a zone to be protected (5). Also depicted therein are disengagement trajectories (3c, 3d) corresponding respectively to the points and angles of attack of the safety volume (2) indicated by the trajectories (4c, 4d) of the aircraft (1).

Other disengagement trajectories may be imagined as a function of the shape of the safety volume (2) and of the position, the speed and the direction of the aircraft (1) when it penetrates the safety volume (2), without thereby departing from the spirit of the invention.

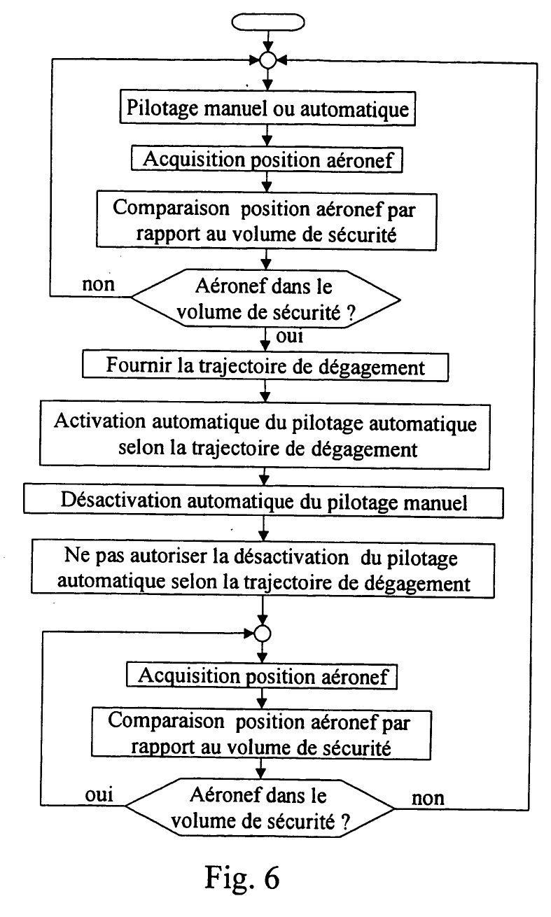

FIG. 6 is a flowchart corresponding to an example of the steps of preferred methods of automatic piloting according to the invention. As may be seen, according to a preferred method, a first further step intervenes when the automatic piloting according to the disengagement trajectory (3) of the aircraft (1) has been activated automatically. This first further step consists in automatically deactivating any other means of piloting of the aircraft (1), such as a means of manual piloting for example. Specifically, although in most cases it is desirable for the pilot to retain control of the aircraft, it may turn out to be necessary for this possibility not to be offered to him. This is in particular again the case upon terrorist acts such as acts aimed at making an aircraft crash on an occupied zone. Specifically, the terrorist must not be able to supervise the aircraft and force a different trajectory from the disengagement trajectory (3) through manual piloting for example.

According to another preferred method, a second further step intervenes likewise when the automatic piloting according to the disengagement trajectory (3) of the aircraft (1) has been activated automatically. This second further step consists in not permitting deactivation of the automatic piloting according to the disengagement trajectory (3). For the same reasons, this effectively makes it possible to prevent a terrorist from being able to supervise the aircraft (1) and force a different trajectory from the disengagement trajectory (3) through deactivation of the automatic piloting.

In a method according to the invention comprising the first and the second further step, the aircraft (1) acts in a totally autonomous manner and nobody on board the aircraft (1) can pilot the aircraft (1) throughout essentially the duration of the disengagement trajectory (3).

Conversely, the safety volume (2) may also represent a compulsory volume. The invention therefore also relates to a method of automatic piloting whose goal is to maintain the aircraft (1) in the safety volume (2). This method is similar to the method described hereinabove, except that in this case the automatic pilot is activated automatically as soon as the aircraft (1) leaves the safety volume (2) so as to pilot the aircraft (1) according to a reinsertion trajectory for re-entering the safety volume (2). Such a method may be used for example when it is simpler to define a compulsory safety volume (2) than to define a prohibited safety volume (2), such as during phases of takeoff and/or of landing of the aircraft (1).

A second aspect of the invention concerns a device for automatic piloting of an aircraft (1). For reasons of simplification, the device will be described in respect of a conventional airliner, although it is equally applicable to any other aircraft (1).

In a simplified manner, an airplane is steered by means of actuators (30) which respond to orders originating from control members.

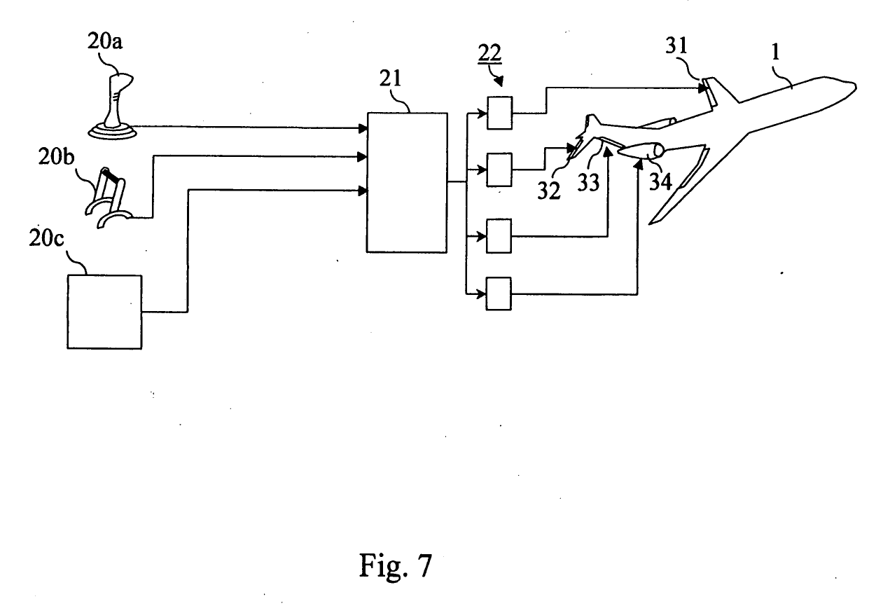

FIG. 7 shows a simplified diagram of a known system for piloting an airplane. Depicted therein is a ministick which is an example of a control member manipulated by a pilot. The ministick sends an order to a flight control computer (21) which provides commands to servocontrols (22) acting on actuators (30) such as rudder (33), elevator (32) and ailerons (31). Thus, when the pilot manoeuvres the ministick, the actuators (30) respond to his request accordingly, thereby making it possible to steer the airplane. The same holds in respect of the control of the throttle of the engine(s) (34).

When the pilot trips the automatic pilot, it is the latter which gives the orders to the flight control computer (21) according to a properly established flight plan.

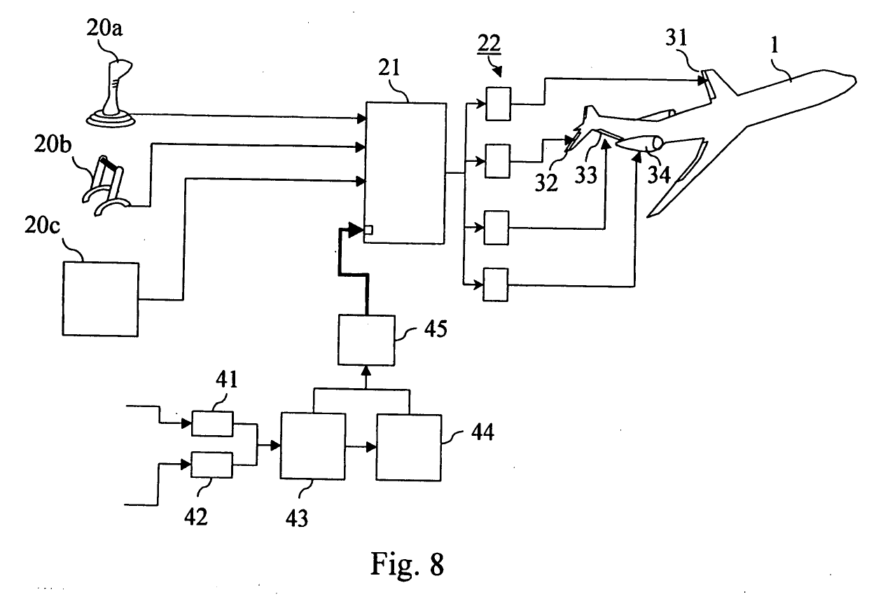

In one embodiment of the device according to the invention, the device comprises means (42) for receiving the coordinates determining the at least one safety volume (2) described hereinabove, means (41) for receiving position coordinates of the airplane (1), and means of comparison (43) for comparing the position of the airplane (1) with the safety volume (2), such as indicated in FIG. 8. The evaluation of position coordinates of the airplane (1) with respect to the coordinates determining the safety volume (2) in fact makes it possible to determine whether the airplane is or is not in the safety volume (2). The device also comprises means (44) for providing a disengagement trajectory for exiting the safety volume (2), and means (45) for sending orders to the flight control computer (21) which—during operation—cause the airplane to automatically follow the disengagement trajectory (3) as soon as the means of comparison (43) have determined that the airplane (1) is in the safety volume (2). Thus, the automatic piloting device according to the invention takes the controls of the airplane automatically when the airplane enters the safety volume (2), and it pilots the airplane so that the latter exits the safety volume (2).

The coordinates determining the at least one safety volume (2) may be stored in existing means of storage in the airplane, such as a navigation database for example.

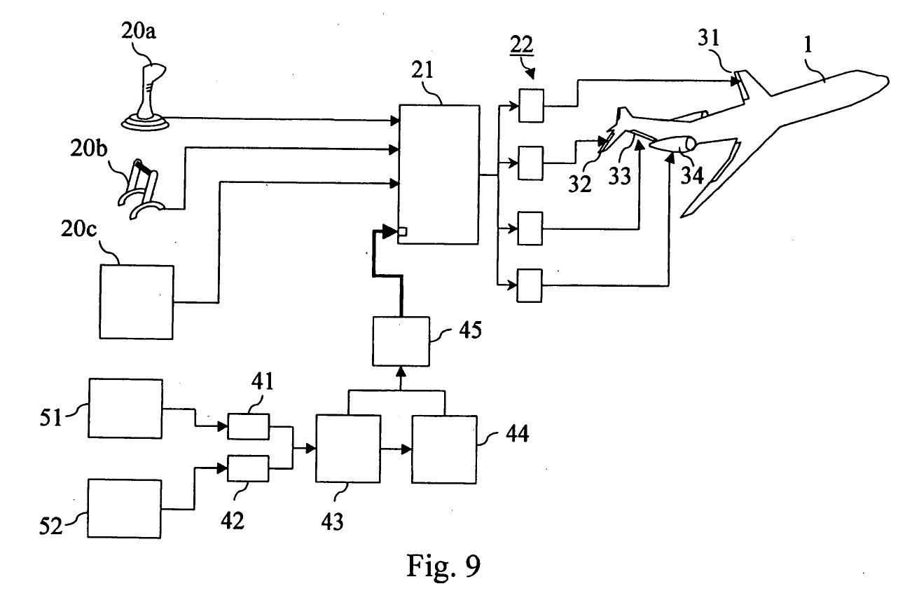

Preferably, the automatic piloting device according to the invention comprises its own means (52) of storage of the coordinates determining the at least one safety volume (2) as may be seen in FIG. 9. This in fact makes it possible to ensure greater inviolability of the said coordinates by making it more difficult to provide the device with deliberately erroneous coordinates.

The coordinates of the position of the airplane may originate from an existing system, such as a GPS system, an inertial system, a system of radio beacons, or any combination of such systems and/or of other systems.

Preferably, the automatic piloting device according to the invention comprises its own means (51) of determining the position coordinates of the airplane, as may also be seen in FIG. 9. This also makes it possible to ensure greater inviolability of the said position coordinates by making it more difficult to provide the device with deliberately erroneous coordinates.

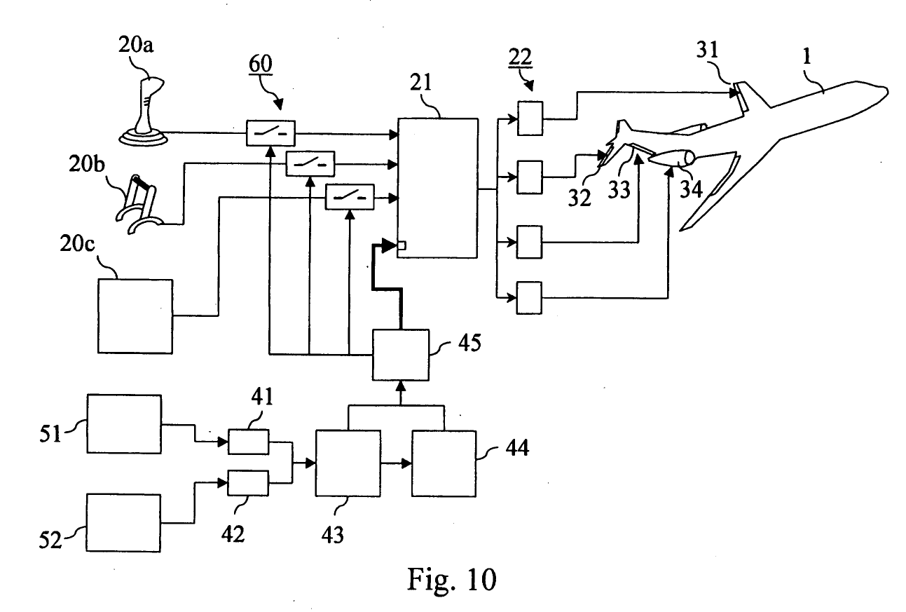

Advantageously, the piloting device according to the invention comprises means (60) for automatically deactivating any other means of piloting of the airplane when the means of comparison (43) have determined—during operation—that the airplane (1) is in the safety volume (2). Thus, the piloting device according to the invention is the only master on board while the airplane is in the safety volume (2). These means (60) of deactivation are deactivated when the airplane has exited the safety volume (2), thereby making it possible from this moment onwards to retake command of the airplane through conventional means, such as through manual piloting for example. FIG. 10 shows an example of such a device in the case of a system where the piloting orders are provided to the flight control computer (21) by way of electrical signals originating from the various means of control: ministick (20a) and throttles (20b) for manual piloting and automatic piloting system (20c) for normal automatic piloting. When the means of comparison (43) have detected that the airplane is in the safety volume (2), the means of deactivation (60) automatically disconnect the ministick (20a), the throttles (20b) and the automatic piloting system (20c), for example by means of switches (60) breaking the link between the control means (20a, 20b, 20c) and the flight control computer (21), in such a way that the airplane is piloted solely by the piloting device according to the invention and is therefore forced to follow the disengagement trajectory (3) without there being any means of counteracting same.

Once the airplane (1) has exited the safety volume (2), the device automatically reconnects the said means of control (20a, 20b, 20c), in this case by turning the switches (60) back on, so that the pilot can retake command of the airplane, for example manually.

Yet more advantageously, the device according to the invention comprises no means intended for deactivating it such as an on/off switch for example.

Conversely, the safety volume (2) may also represent a compulsory volume. The invention therefore also relates to an automatic piloting device whose goal is to maintain the aircraft (1) in the safety volume (2). In this case, the means of comparison (43) of the device according to the invention comprise means (44) for providing a reinsertion trajectory for re-entering the safety volume (2), and means (45) for—during operation—automatically sending orders to the flight control computer (21) which automatically make the airplane follow the reinsertion trajectory as soon as the means of comparison (43) have determined that the airplane (1) has exited the safety volume (2).

A third aspect of the invention concerns a system for automatic piloting of an aircraft (1), such as described in the claims.

To summarize, the method of the invention may be described as follows:
method consisting in comparing the position of an aircraft (1) with respect to at least one safety volume (2) whose coordinates are stored on board the aircraft (1).

As soon as it is detected that the aircraft (1) has entered the at least one safety volume (2), means of automatic piloting are activated automatically—hence with no human intervention—and pilot the aircraft (1) according to a disengagement trajectory (3) for exiting the safety volume (2), until the aircraft (1) has left the safety volume (2).

1. Method of automatic piloting of an aircraft (1) on board of which has been stored a set of coordinates determining at least one safety volume (2), characterized in that the method comprises the following steps:
monitoring whether the aircraft (1) is in the at least one safety volume (2) by comparing position coordinates of the aircraft with respect to the coordinates determining the at least one safety volume;
providing a disengagement trajectory (3) for exiting the at least one safety volume (2) and automatically activating means of automatic piloting of the aircraft (1) according to the said disengagement trajectory (3) as soon as the aircraft is in the at least one safety volume (2).

2. Method of automatic piloting of an aircraft (1) according to claim 1, characterized in that the method comprises a further step consisting in recording in storage means (52) on board the aircraft the set of coordinates determining the at least one safety volume (2).

3. Method of automatic piloting of an aircraft (1) according to either of claims 1 or 2, characterized in that once the means of automatic piloting of the aircraft (1) according to the disengagement trajectory (3) have been activated, any other means of piloting is automatically deactivated so that these other means cannot modify the trajectory of the aircraft while the aircraft is in the safety volume (2).

4. Method of automatic piloting of an aircraft (1) according to any one of claims 1 to 3, characterized in that once the means of automatic piloting of the aircraft (1) according to the disengagement trajectory (3) have been activated, they can not be deactivated while the aircraft (1) is in the safety volume (2).

5. Method of automatic piloting of an aircraft (1) on board which has been stored a set of coordinates determining at least one safety volume (2), characterized in that the method comprises the following steps:
monitoring whether the aircraft (1) is in the at least one safety volume (2) by comparing position coordinates of the aircraft (1) with respect to the coordinates determining the at least one safety volume (2);
providing a reinsertion trajectory for re-entering the at least one safety volume (2) and automatically activating means of automatic piloting of the aircraft (1) according to the said reinsertion trajectory as soon as the aircraft (1) has exited the at least one safety volume (2).

6. Method of automatic piloting of an aircraft (1) according to claim 5, characterized in that the method comprises a further step consisting in recording in storage means (52) on board the aircraft (1) the set of coordinates determining the at least one safety volume (2).

7. Method of automatic piloting of an aircraft (1) according to either of claims 5 or 6, characterized in that once the means of automatic piloting of the aircraft (1) according to the reinsertion trajectory have been activated, any other means of piloting is automatically deactivated so that these other means cannot modify the trajectory of the aircraft (1) while the aircraft (1) is in the safety volume (2).

8. Method of automatic piloting of an aircraft (1) according to any one of claims 5 to 7, characterized in that once the means of automatic piloting of the aircraft (1) according to the reinsertion trajectory have been activated, they can no longer be deactivated while the aircraft (1) is in the safety volume (2).

9. Device for automatic piloting of an aircraft (1), the aircraft being equipped with means (21) of control of trajectory of the said aircraft, characterized in that the device comprises:
first means (41) for receiving coordinates of a position of the aircraft (1),
second means (42) for receiving coordinates determining at least one safety volume (2),
means of comparison (43) of the coordinates of the position of the aircraft (1) and of the coordinates determining the at least one safety volume (2),
means (44) for providing a disengagement trajectory (3) for exiting the safety volume (2),
means of sending orders (45) to the means (21) of control of trajectory, under the dependence of the said means of comparison (43) and of the said means (44) for providing a disengagement trajectory (3), such that when—during operation—the means of comparison (43) have determined that the position of the aircraft (1) is in the at least one safety volume (2), the means of sending orders (45) automatically send orders to the means (21) of control of trajectory causing the aircraft (1) to follow the disengagement trajectory (3) for exiting the safety volume (2).

10. Device for automatic piloting of an aircraft (1) according to claim 9, characterized in that the device furthermore comprises means (52) of storage of the coordinates determining the at least one safety volume (2), providing—during operation—the coordinates determining the at least one safety volume (2) to the first means (41) of reception.

11. Device for automatic piloting of an aircraft (1) according to either of claims 9 to 10, characterized in that the device furthermore comprises means (51) of determination of the position coordinates of the aircraft (1), providing—during operation—the position coordinates of the aircraft (1) to the second means (42) of reception.

12. Device for automatic piloting of an aircraft (1) according to any one of claims 9 to 11, characterized in that the device furthermore comprises means (60) of deactivation of any other means of sending orders to the means (21) of control of trajectory, the said deactivation taking place automatically—during operation—when the means of comparison (43) have determined that the position of the aircraft (1) is in the at least one safety volume (2).

13. System for automatic piloting of an aircraft (1), characterized in that the system comprises:
means (21) of control of trajectory of the said aircraft (1),
first means (41) for receiving coordinates of a position of the aircraft (1),
second means (42) for receiving coordinates determining at least one safety volume (2),
means of comparison (43) of the coordinates of the position of the aircraft (1) and of the coordinates determining the at least one safety volume (2),
means (44) for providing a disengagement trajectory (3) for exiting the safety volume (2),
means of sending orders (45) to the means (21) of control of trajectory, under the dependence of the said means of comparison (43) and of the said means (44) for providing a disengagement trajectory (3), such that when—during operation—the means of comparison (43) have determined that the position of the aircraft (1) is in the at least one safety volume (2), the means of sending orders (45) automatically send orders to the means (21) of control of trajectory causing the aircraft (1) to follow the disengagement trajectory (3) for exiting the safety volume (2).
